(19) United States
(12) Patent Application Publication
(10) Pub. No.: US 2009/0266605 A1
(43) Pub. Date: Oct. 29, 2009

(54) HIGH VOLTAGE VALVE GROUP WITH INCREASED BREAKDOWN STRENGTH

(75) Inventors: Li Ming, Vasteras (SE); Dong Wu, Ludvika (SE)

Correspondence Address: VENABLE LLP, P.O. BOX 34385, WASHINGTON, DC, 20043-9998, US

(73) Assignee: ABB RESEARCH LTD., Zurich (CH)

(21) Appl. No.: 12/305,999

(22) PCT Filed: Jun. 20, 2006
(86) PCT No.: PCT/SE2006/000748

§ 371 Date: Jun. 5, 2009

(51) Int. Cl. H02B 1/06

(52) U.S. Cl. 174/5 R

(57) ABSTRACT

A high voltage assembly including a valve group and a shield connected to the valve group. A resistor is connected between the shield and the valve group The assembly provides an increased breakdown strength and DC withstand level.

### FIELD OF THE INVENTION

The present invention relates to the field of high voltage devices and in particular to a high voltage assembly as defined in the preamble of claim 1.

### BACKGROUND OF THE INVENTION

Electrical power transmission can be accomplished by high-voltage direct current (HVDC) and HVDC is in many cases a preferred option over AC transmission.

In electrical plants means for performing a conversion from HVDC to three-phase AC are needed, and vice versa. A HVDC power converter comprises a number of valves, which are key components of electrical plants, and the valves are typically accommodated in a valve hall. An example of such valve is the thyristor valve, often utilized for making the conversion between DC/AC.

When designing a valve hall several considerations have to be taken into account. The security aspects are very important and require the valve hall to have some minimum space dimensions. For example, the air clearance between a power converter and the walls and ceiling of the valve hall within which it resides should in some cases be up to about ten meters and in others only a few meters. The dimensions of the valve hall are highly dependent on the voltage levels of the electrical power distribution network. The higher the voltage, the more distance to the surroundings is generally needed. The dimensions of the valve hall are determined by the intended application, the design of the valve structure and the adjacent structures, among other factors.

However, in contrast to this, there is also a desire for the valve halls to be as small as possible. Land space is often scarce and expensive and there is therefore a desire to keep the size of the valve halls down. Further, different countries stipulate different regulations and in some countries building permits may be difficult to obtain. Further yet, also aesthetic aspects make it more desirable to provide small and compact sub-stations, so that they affect the environment to as little extent as possible. The investment and installation costs, including for example material costs and labour costs, may in some countries be high and thus further yet adds to the desire to minimize the size the valve hall.

The security in a high voltage application such as a power converter is of great concern. Hazards in connection with power transformers comprise for example electric discharges; power failures due to high-intensity electric arcs may black out very large areas and are expensive for the power companies. Protection measures, either passive or active, are therefore crucially important.

In view of the above, it would be desirable to provide an improved high voltage assembly, providing an increased security. Further, it would be desirable to provide means to enable designing valve halls of smaller size, without lessening the security requirements.

### SUMMARY OF THE INVENTION

It is an object of the present invention to provide an improved high voltage structure having a higher security marginal, thereby overcoming or at least alleviating the above-mentioned drawbacks of the prior art.

It is another object of the present invention to provide an improved high voltage structure, enabling the use of valve halls a more compact design, but still with an maintained or increased security level.

These objects, among others, are achieved by a high voltage assembly as claimed in claim 1.

In accordance with the invention a high voltage assembly is provided. The high voltage assembly comprises a valve group and a shield, wherein the shield is connected to the valve group. In accordance with the invention a connection resistance is provided between the shield and the valve group. By means of the invention the impulse breakdown strength can be increased. Further, increased DC withstand levels can also be accomplished. An improved safety in HVDC valve halls can thereby be provided, without increasing the size of the valve hall within which the valves are accommodated. This improvement can further, by minor changes, be implemented in existing HVDC valves, and thereby renders the invention suitable and most attractive also to existing HVDC valves. By means of the invention, the operation reliability can be greatly improved.

In accordance with an embodiment of the invention, connection resistance is a resistor. Further, the resistance value of the resistor lies preferably within the range of 2 MΩ-40 MΩ, but preferably larger than 2 MΩ. This is a suitable range for the resistance for providing a higher security and avoiding air breakdowns. Further, such resistance values enable the use of components readily available on the market.

Further preferred embodiments of the present invention are defined in the dependent claims.

Further characteristics, advantages and objects of the invention will become apparent by reading the following detailed description.

### BRIEF DESCRIPTION OF THE DRAWINGS

FIG. 1 illustrates breakdown voltages of toroid/plane air gaps.

FIG. 2 illustrates schematically a valve structure in accordance with a prior art solution.

FIG. 3 illustrates schematically an embodiment of the high voltage assembly in accordance present invention.

FIG. 4 illustrates schematically a embodiment of the high voltage assembly in accordance the present invention.

### DETAILED DESCRIPTION OF PREFERRED EMBODIMENTS

As was explained in the introductory part of the present application, the HVDC valve hall dimensions depend directly on the air clearances required between the earthed walls of the valve hall and the different energized elements, such as the valves. In order to decrease the air clearance, the configuration of the high voltage shields is carefully designed.

The published document entitled “Inhibited electrical discharges in air”, by Anders Larsson, Uppsala University, 1997, discusses experimental results of inhibited discharge measurements. It is shown that the magnitude of the 50% disruptive voltage U_{50%} and the SI (switching impulse) breakdown voltage was increased with 20% with a series resistor of 4 MΩ added. The published document entitled “Über ungewöhnlich groβe schalgweiten in luft bei hohen gleichspannugen”, VDE Fachberichte 12, Band 1948, Gruppe VIII, Elecktrophysik, reports on measurements made regarding breakdown phenomena. It was found that DC disruptive discharges could, under some circumstances, occur for electric field strengths below the expected values. Such anomalous discharges occurred between spherically shaped electrodes and the walls of the room, and discharges were observed already at an average electric field strength of 3 kV/cm.

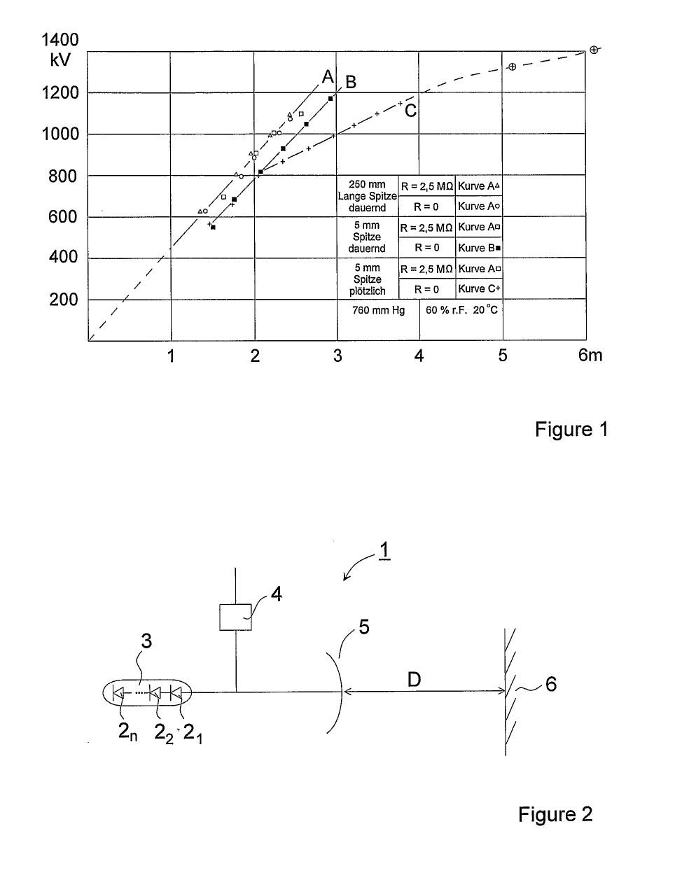

FIG. 1 illustrates the reported results for the experimental arrangement utilized. The arrangement included a protruding tip and the measuring results of graph A illustrates expected values for such a field and thus follow the known correlation between breakdown voltages and breakdown distances. Graphs A and B illustrate the results for a tip protruding 250 mm and 5 mm, respectively, and with and without a connection resistance. Graph A is always followed when a connection resistance R of 25 MΩ is utilized. Graph B shows the results when the connection resistance R was short-circuited and the tip was protruding 5 mm. Graph C illustrates anomalous discharges occurring when the connection resistance R of the arrangement was short-circuited, i.e. when R=0Ω, and when the protruding tip was moved and suddenly pushed through the electrode. The anomalous discharges were believed to occur due to conducting particles moving into the air gap close to the high voltage electrode within the arrangement.

The inventors of the present invention have, based on the knowledge from the above cited references, found a way to accomplish an improved performance of a HVDC system. In particular, the experimental results presented in the above cited references were the starting point for providing an improvement in an electrical plant application. More specifically, the inventors of the present invention have realized that these findings can be utilized in an innovative way for providing an improved high voltage shielding of valves.

FIG. 2 illustrates schematically a state of the art design of a high voltage assembly, and in particular a valve structure 1. The valve structure 1 comprises a number of valves 2₁, 2₂, 2ₙ, for example six valves arranged in a valve group 3. It is realized that the valve structure 1 can be utilized for converting electric power from DC to AC, i.e. a rectifier, and for converting electric power from AC to DC, i.e. an inverter. The valve group 3 is connected to a busbar 4 in a conventional manner. As is well known, the busbar 4 is arranged to conduct electricity to a receiving end, such as another converter station. Finally, the valve group 3 is connected to a shield 5 preventing corona discharge and arcing.

In the figure, a wall 6 of the valve hall within which the valve structure is housed, is shown. The required distance D between the valve structure 1 and the surrounding earthed walls is in many applications within the range of about 6-10 meters, but can be smaller or larger depending on the specific application. This distance is the so called air clearance.

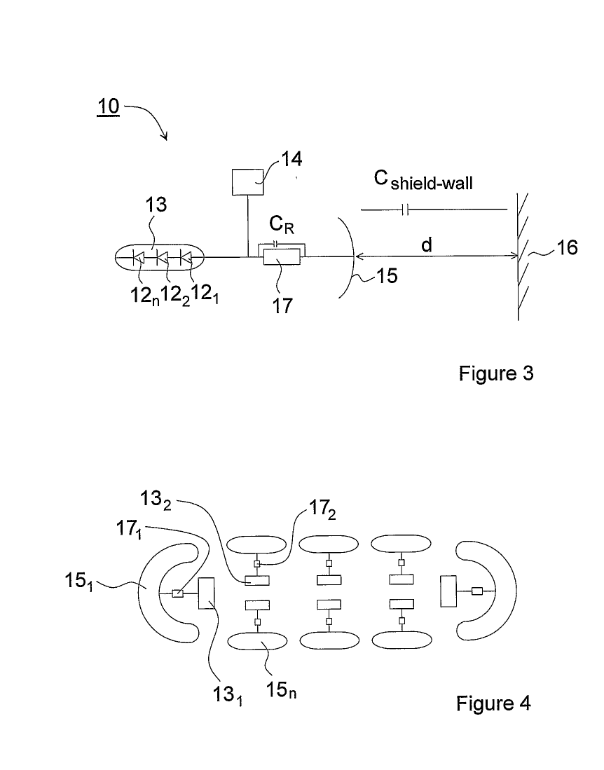

FIG. 3 illustrates schematically an embodiment of the present invention. Only the parts needed for the understanding of the invention are shown and described. It is realized that other parts that are conventionally included in a high voltage power converter may be included, when the invention is implemented in such high voltage assembly. As in the prior art, the high voltage assembly, which in the illustrated example is a valve structure, in accordance with the invention comprises a number of valves 12₁, 12₂, 12ₙ, arranged in a valve group 13. There are usually several such valve groups 13 within a valve structure, arranged in multiple layers each layer comprising a number of valve groups. It is realized that the invention can be implemented in any known valve configuration, for example in a twelve pulse valve group. The valves 12₁, 12₂, 12ₙ, are connected to a busbar 14, providing means for conducting electricity in a conventional manner. A shield or corona shield, in the following simply shield 15 is also provided. The shield 15 could be of any conventional type, such as for example made of an aluminum sheet. There is a multitude of electrically conducting shields available that can be utilized in the inventive arrangement. The shape of the shield 15 is preferably curved, for example spherical. It is thus realized that the shield 5 could be any suitable barrier or enclosure that limits the penetration of an electric field.

The present invention introduces a connection resistance 17 between the shield 15 and the valve group 13. The connection resistance 17 may for example be one or more resistors. In a preferred embodiment, the resistor or resistors have a resistance value of 4 MΩ. However, it is realized that any suitable resistance value could be chosen, for example lying within the range of approximately 2 MΩ and 40 MΩ. The connection resistance should preferably be higher than 2 MΩ. However, it is realized that the designer should choose a suitable value, which value depend on the particular application in question.

Any type of resistor can be utilized, such as for example water resistors that are able to handle high voltages. Other examples comprise wirewound resistors and metal film resistors. In an embodiment of the invention, the connection resistance 17 is variable, thereby providing adjustment means should such need arise.

As is well known, all real resistors also introduce some inductance and a small amount of capacitance, which change the dynamic behavior of the resistor from the ideal. Capacitance exists since any pair of electrical conductors that will store electrical charge when a difference of potential is applied to them constitutes capacitance. All parts of a resistor and its terminals, and all parts of a resistor in association with all its other parts have that characteristic and thus a small amount of capacitance is introduced.

In accordance with the invention, the resistance value and the corresponding capacitance of the resistor 17 is controlled and chosen in a suitable manner. In FIG. 3, the capacitance of the resistor 17 is indicated by C_{R}. There is also, in analogy with the above, some capacitance C_{shield-wall} between the shield 15 and its surrounding walls 16. This capacitance may for example be about twenty or thirty pF, but is highly dependent on the geometry of the constituent parts, such as the distance between the wall 16 and the shield 15 and their respective areas. In accordance with the invention, the capacitance C_{R} of the resistor 17 is chosen to be much higher than the capacitance of the air C_{shield-wall},i.e. C_{R}>>C_{shield-wall}. The capacitance of the resistor 17 could for example be several hundred times larger than the capacitance of the air C_{Shield-wall}, or several thousand times larger, and preferably about 10 000 to 1 000 000 times higher. Thereby, the resistor 17 is hindered from being physically damaged, that is, hindered from being overheated or burnt up, for instance, during normal operation. However, the resistor 17 inhibits any breakdown process and thereby increases the operation reliability considerably.

As mentioned earlier, there are usually several valve groups 13 within a valve structure. FIG. 4 illustrates a very schematic top view of one layer of such valve structure. Several such layers may be arranged on top of each other, in a conventional manner. In an embodiment of the invention, each valve group 13, 13₂, . . . , 13ₙ that is connected to a shield 15₁, 15₂, . . . , 15ₙ may comprise a connection resistance 17₁, 17₂, . . . , 17ₙ in accordance with the invention.

The operation reliability of HVDC systems can be greatly improved by means of the present invention. In particular, the impulse breakdown strength can be increased, since the resistor 17 inhibits the breakdown process. Further, the DC withstand levels can also be increased.

In accordance with the present invention, the security level of a high voltage application can be greatly increased.

In accordance with the present invention, the air clearance distance d can be reduced by approximately 10-20%, which is a substantial size reduction. This reduced air clearance requirement can be utilized for reducing the size of the valve hall. Alternatively, the reduced air clearance requirement can be utilized for providing further yet increased operation reliability of the HVDC system.

In the present application a high voltage can be considered to range from about 1 kV up to as much as 800 kV DC, but most often in the range of 50 kV-800 kV DC. Transient over voltages may occur occasionally in any system and may reach up to approximately 2-3 MV.

High voltage assemblies, in which the present invention can be utilized, comprise for example power converters or power transformers. However, it is realized that other high voltage applications may benefit from the present invention.

In summary, the present invention provides an improvement to high voltage assemblies, such as a power converter or power transformer or, in particular, a valve structure. By means of the invention the impulse breakdown strength can be increased as can the DC withstand levels. An improved safety in HVDC valve halls can thereby be provided, without increasing the size of the valve hall within which the valves are accommodated. This improvement can further, by minor changes, be implemented in existing HVDC valve halls, and thereby renders the invention suitable and most attractive also to existing high voltage assemblies. By means of the invention, the operation reliability can be greatly improved.

1. A high voltage assembly, comprising:
a valve group,
a shield connected to said valve group, and
a connection resistance connected between said shield and said valve group, whereby increased breakdown strength and DC withstand level are obtained.

2. The high voltage assembly according to claim 1, wherein said connection resistance comprises a resistor.

3. The high voltage assembly according to claim 2, wherein said resistor has a resistance value within the range of 2 MΩ-40 MΩ.

4. The high voltage assembly according to claim 1, wherein said valve group comprises thyristor valves arranged in a twelve pulse valve group.

5. The high voltage assembly according to claim 1, wherein said connection resistance has a controlled capacitance.

6. The high voltage assembly according to claim 5, wherein said controlled capacitance is much larger than the capacitance between the shield and an adjacent wall.

7. The high voltage assembly according to claim 6, wherein said controlled capacitance is about one thousand times larger than capacitance between the shield and an adjacent wall.

8. The high voltage assembly according to claim 1, wherein said connection resistance comprises a water resistor.

9. The high voltage assembly according to claim 1, wherein said shield is comprises a metallic shield.

10. The high voltage assembly according to claim 1, further comprising
a plurality of shields,
a plurality of valve groups, and
a connection resistance connected between each shield and a respective valve group.

11. The high voltage assembly according to claim 1, wherein said high voltage assembly is a high voltage power converter.
